(19) United States
(12) Patent Application Publication
(10) Pub. No.: US 2004/0141708 A1
(43) Pub. Date: Jul. 22, 2004

(54) Optical fiber retaining method and apparatus thereof

(76) Inventors: Takashi Yokobiki, Tokyo (JP); Tatsuya Shimobachi, Tokyo (JP)

Correspondence Address: CHRISTIE, PARKER & HALE, LLP, P.O. BOX 7068, PASADENA, CA, 91109-7068, US

(21) Appl. No.: 10/665,686

(22) Filed: Sep. 17, 2003

(30) Foreign Application Priority Data
Jan. 17, 2003 (JP) 2003-010232

(51) Int. Cl. G02B 6/00

(52) U.S. Cl. 385/137

(57) ABSTRACT

An optical fiber retainer comprises an adhesive to adhere a plurality of optical fibers together which align like a ribbon to form ribbonized optical fibers, a heat shrink tube to contain the ribbonized optical fibers and a support to firmly hold the ribbonized optical fibers and the support through heat-shrinking, and a stand to hold the heat shrink tube, wherein the adhesive is applied to the plurality of optical fibers at inside and outside of the heat shrink tube after the heat-shrinking.

### CROSS REFERENCE TO RELATED APPLICATIONS

This application claims priority to Japanese Patent Application No. 2003-010232, filed Jan. 17, 2003, the entire contents of which are incorporated herein by reference.

### FIELD OF THE INVENTION

This invention relates to an optical fiber retaining method and apparatus thereof suitable for holding a plurality of optical fibers on a predetermined position.

### BACKGROUND OF THE INVENTION

An optical fiber usually includes a core to propagate light waves and a cladding surrounding the core, the cladding having a refractive index lower than that of the core. For chemical and physical protection, optical fibers are coated with plastic coating. An optical cable is made from such optical fiber or a plurality of such optical fibers. Generally, an optical cable also includes one or more high strength steel wires to resist vertical tensile force. Optical cables are classified into two types, one is a fixed system to hold one or more optical fibers firmly in the cable and the other is a loose tube system to keep one or more optical fibers vertically movable in a tube. In the loose tube system, generally a plurality of high strength steel wires are disposed surrounding the loose tube storing the optical fibers.

When optical fibers in two optical cables are connected together, it is necessary to pull the optical fibers out of each cable and to hold the fibers on predetermined positions. Such methods for pulling out and retaining optical fibers are disclosed in Japanese Laid-Open Patent No.2001-108440 and U.S. Pat. No. 6,438,300.

In the method described in Japanese Laid-Open Patent No. 2001-108440, optical fibers are coated with UV cured resin, which is almost identical to the coating material of the optical fibers, and ribbonized through UV radiation. The ribbonized optical fibers are temporarily set into a trough, and then UV cured resin is poured into the trough to fix the optical fibers through UV radiation. This method can suppress the increase of lateral pressure toward the optical fibers and consequently the increase of transmission loss can be suppressed.

In the method disclosed in U.S. Pat. No. 6,438,300, a shrink tube is used. A plurality of optical fibers pulled out from an optical cable are fixed like a ribbon by an adhesive. Two semicylindrical supports, one is made from glass and the other from plastic, are disposed in the shrink tube in advance, and the ribbonized optical fibers are inserted between the two supports. In this state, the shrink tube is heated. The shrink tube shrinks with the heat and accordingly the optical fibers inside the shrink tube are firmly held between the two supports. After that, the shrink tube is disposed in a trough of a retainer and fixed on a housing. High-strength steel wires of the optical cables are attached to the housing.

When two optical cables are connected, the operations to retain optical fibers are performed in the field. Accordingly, it is necessary to make the operations easier. In addition, it is necessary to use a method in which the increase of transmission loss in optical fibers is small. It is desirable that joint parts of an optical cable are compact. To make the joint parts compact, it is first required to make its components smaller.

In the operations in the field, it is easier to use heat-shrinkable plastic than to use UV cured resin. The primary factor of the transmission loss is a bend of the optical fiber. Although the method disclosed in the above U.S. patent has a merit that it can easily keep optical fibers in a straight state after the heat-shrinkage operation because the ribbonized optical fibers are sandwiched by the two supports, it is not easy to insert the ribbonized optical fibers sandwiched by the two supports into the shrink tube in view of the smallness of the shrink tube and supports.

Since many optical fibers are contained in an optical cable, it is desirable to provide a retainer capable of retaining a larger number of optical fibers together. When the splice procedure is considered, it is desirable to have a plurality of optical fibers ribbonized. To take those demands into consideration, the number of optical fibers to be hold in a single shrink tube is limited to 8 to 16. When it is desired to retain optical fibers exceeding this limit in a lump, it is necessary to provide a plurality of shrink tubes. In this case, when the configuration disclosed in the aforementioned U.S. patent is used, the distance between optical fibers fixed in two separated shrink tubes becomes larger than the sum of thickness of two supports since the ribbonized optical fibers are sandwiched by two supports in each shrink tube. The more positions to retain optical fibers pulled out from one optical cable are apart, the more the distance between a retainer and the optical cable lengthens. If the distance is not long enough, the optical fibers are forced to bend in a short curvature radius, as a result, the loss becomes larger.

### SUMMARY OF THE INVENTION

According to the invention, an optical fiber retaining method comprises steps of forming ribbonized optical fibers by applying a first adhesive to a plurality of optical fibers which align like a ribbon, inserting the ribbonized optical fibers and a support in a heat shrink tube, holding the ribbonized optical fibers and the support firmly in the heat shrink tube by heating the heat shrink tube to shrink, and fixing the shrunken heat shrink tube on a stand by a second adhesive, wherein the first adhesive is applied to the plurality of optical fibers at inside and outside of the heat shrink tube.

According to the invention, an optical fiber retainer comprises an adhesive to adhere a plurality of optical fibers together which align like a ribbon to form ribbonized optical fibers, a heat shrink tube to contain the ribbonized optical fibers and a support to firmly hold the ribbonized optical fibers and the support through heat-shrinking, and a stand to hold the heat shrink tube, wherein the adhesive is applied to the plurality of optical fibers at inside and outside of the heat shrink tube after the heat-shrinking.

According to the invention, an optical fiber retainer comprises a first optical fiber holder to contain a first ribbonized optical fibers and a first support with a semicylindrical section and to hold the first ribbonized optical fibers adjacent to a side of the first support, a second optical fiber retainer to contain a second ribbonized optical fibers and a second support with a semicylindrical section and to hold the second ribbonized optical fibers adjacent to a side of the second support, and a stand to hold the first and second optical fiber retainers so that the first ribbonized optical fibers held by the first optical fiber holder and the second ribbonized optical fibers held by the second optical fiber holder are close to each other.

### BRIEF DESCRIPTION OF THE DRAWINGS

The above and other objects, features and advantages of the present invention will be apparent from the following detailed description of explanatory embodiments of the invention in conjunction with the accompanying drawings, in which:

FIG. 1 is an exterior perspective view of an explanatory embodiment according to the invention;

FIG. 2 is a perspective view of components of an optical fiber holder 26 according to the explanatory embodiment;

FIG. 3(1) to FIG. 3(5) are schematic diagrams showing the procedure to fix optical fibers 12-1 to 12-8 to the optical fiber holder 26; and

FIG. 4 is a side view in which two optical fiber holders are disposed in parallel.

### DETAILED DESCRIPTION

Explanatory embodiments of the invention are explained below in detail with reference to the drawings.

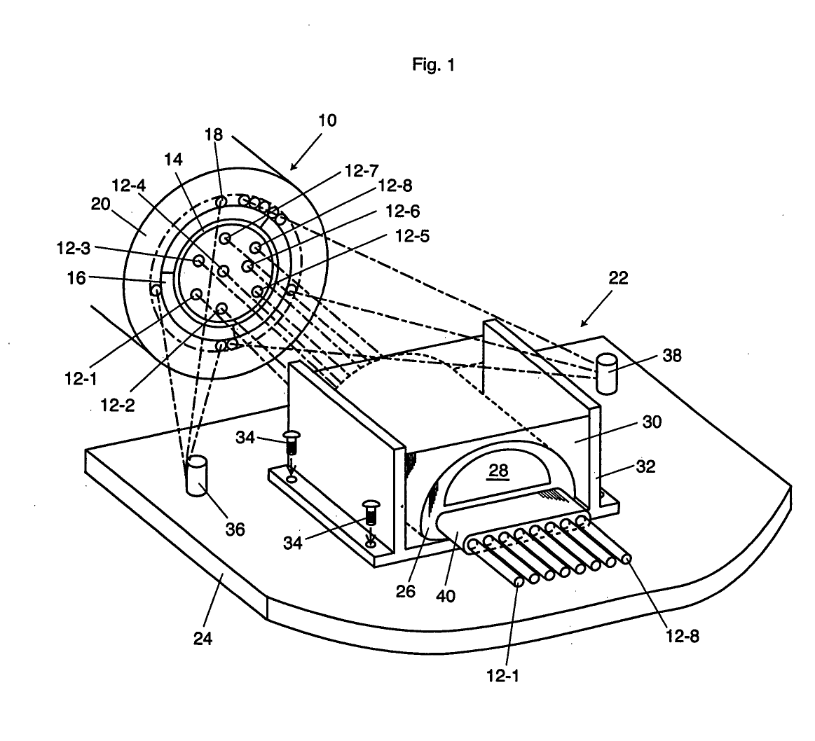

FIG. 1 shows a perspective view in which optical fibers are retained according to an explanatory embodiment of the invention. To make it understandable, the drawing is suitably enlarged vertically and horizontally.

An optical cable 10 comprises a loose tube configuration and FIG. 1 illustrates main elements alone. A plurality (eight in FIG. 1) of optical fibers 12-1 to 12-8 and gel material such as thixotropic gel are loosely contained in a loose tube 14 made from e.g. polyethylene terephthalate. The loose tube 14 is contained in a steel segment 16 divided into three portions in the radial direction. High strength steel wires 18 are disposed outside the steel segment 16. A coating 20 made from polyethylene coats the whole elements. Such optical cable is described in Japanese Laid-Open Patent No. 2001-154070, U.S. Pat. No. 4,645,298, U.S. Pat. No. 4,826,278, U.S. Pat. No. 4,701,016, and U.S. Pat. No. 4,971,419.

An optical fiber retainer 22 is disposed on a location wherever it is necessary to retain optical fibers such as a joint apparatus of two optical cables, an optical repeater, optical amplifier, an optical transmitter, and an optical receiver. In FIG. 1, the optical fibers 12-1 to 12-8 and the high strength steel wires 18 located between the optical cable 10 and optical fiber retainer 22 are illustrated in the alternate long and short dash line.

A baseplate 24 of the optical fiber retainer 22 is fixed on a housing, which is not illustrated in the drawing. The optical fibers 12-1 to 12-8 pulled out from the optical cable 10 are held like a ribbon by an optical fiber holder 26. The optical fiber holder 26 also holds a semicylindrical support 28 which extends parallel to the optical fibers 12-1 to 12-8. The support 28 is inserted in the optical fiber holder 26 in order to suppress the distortion of the optical fiber holder 26 both transversely and axially. The support 28 comprises glass or plastic and preferably comprises a material having expansivity identical or similar to that of the optical fibers 12-1 to 12-8. By fixing the optical fibers 12-1 to 12-8 on the flat side part of the support 28, not only the single support 28 can have satisfactory holding capability to keep the optical fibers 12-1 to 12-8, but also the retaining part can be miniaturized.

The optical fiber holder 26 is fixed on a metal stand 32 by an adhesive 30. The stand 32 has walls on both left and right ends and is capable of holding the optical fiber holder 26 between the walls. The stand 32 is fixed on the baseplate 24 with screw bolts 34. Instead of using the stand 32, it is also applicable that the baseplate 24 itself has a trough capable of holding a part of the optical fiber holder 26 and the optical fiber holder 26 is embedded in the trough and adhered by an adhesive.

The process of fixing the optical fibers 12-1 to 12-8 on the optical fiber holder 26 is explained later in detail.

The half of the high strength steel wires 18 of the optical cable 10 are connected to a pin 36 on the baseplat 24 and the other half are connected to a pin 38 on the baseplate 24. The stand 32 is fixed on the baseplate 24 between the pins 36 and 38. The method to fix the high strength steel wires 18 to the baseplate 24 is not limited to this one illustrated in the drawing and it is obviously possible to employ other methods.

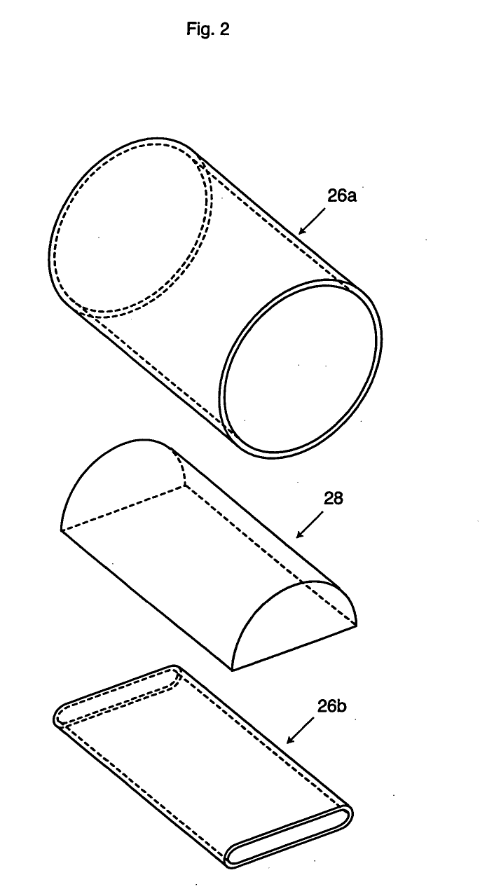

FIG. 2 shows an analytical perspective view of the optical fiber holder 26 before the application. The optical fiber holder 26 comprises, as basic components, a heat shrink tube 26a, the support 28, and a heat dissolving tube 26b. The heat dissolving tube 26b has a size capable of containing the ribbonized optical fibers 12-1 to 12-8. The heat shrink tube 26a has a size capable of containing the heat dissolving tube 26b and the support 28 together. The heat shrink tube 26a comprises plastic material which shrinks with the heat of approximately 130° C. and the heat dissolving tube 26b comprises plastic material which melts with the heat of approximately 130° C.

The length of the heat shrink tube 26a, support 28, and heat dissolving tube 26b are identical. Since the heat shrink tube 26a becomes shorter when heated, the support 28 can be slightly shorter than the heat shrink tube 26a.

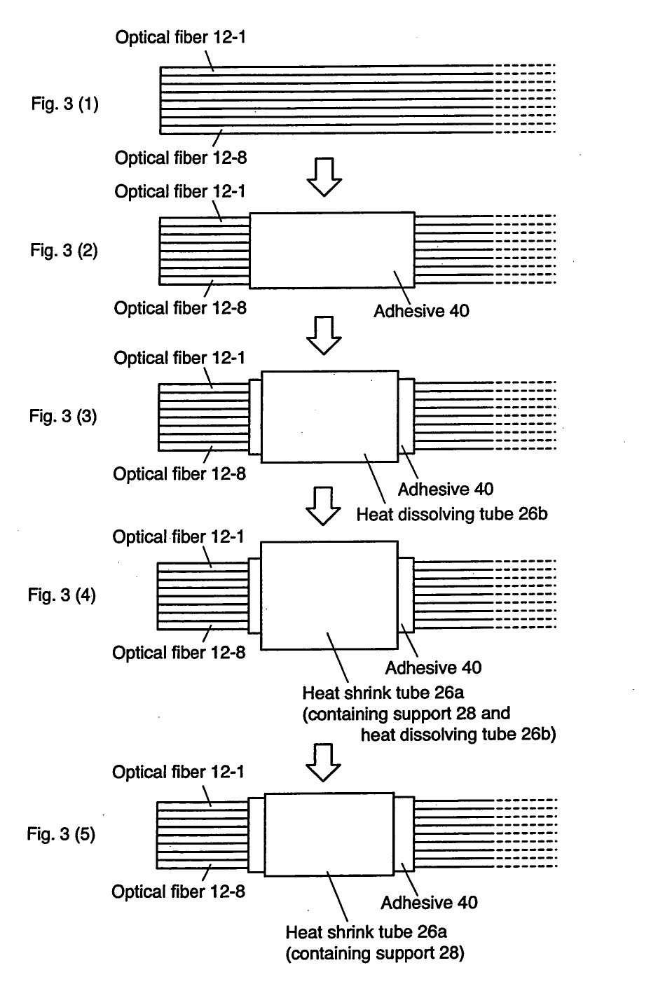

FIG. 3 shows the process for fixing the optical fibers 12-1 to 12-8 on the optical fiber holder 26 according to the explanatory embodiment.

The optical fibers 12-1 to 12-8 are pulled out from the optical cable 10 through stripping off the coating 20. The pulled out optical fibers 12-1 to 12-8 are temporarily aligned together like a ribbon with, for example, clips as shown in FIG. 3(1) and adhered each other with an adhesive 40. However, the adhesive 40 is not necessarily applied on all over the optical fibers 12-1 to 12-8 evenly in the heat shrink tube 26a. Preferably, the strength of the adhesive 40 is between the strength of the optical fibers 12-1 to 12-8 and that of the heat shrink tube 26a. In this point, an acrylic adhesive is suitable as the adhesive 40. It is preferable that the adhesive 40 is applied on the optical fibers 12-1 to 12-8 widely so that it protrudes from the heat shrink tube 26a. With this operation, the durability for the external force, bending, and temperature variation affecting to the optical fibers 12-1 to 12-8 becomes larger and the occurrence of microbend causing a bending loss can be suppressed.

The optical fibers 12-1 to 12-8 fixed each other like a ribbon as shown FIG. 3(2) are inserted in the heat dissolving tube 26b as shown FIG. 3(3). Then, the heat dissolving tube 26b and support 28 are inserted together into the heat shrink tube 26a as shown in FIG. 3(4). Practically, the support 28 and heat dissolving 26b are temporarily fixed to an appropriate position in the heat shrink tube 26a in advance and then the ribbonized optical fibers 12-1 to 12-8 applied with the adhesive 40 are inserted in the heat dissolving tube 26b.

In the condition shown in FIG. 3(4), the heat shrink tube 26a is heated to 100° C. to 130° C. Then, the heat dissolving tube 26b melts down and penetrates among the optical fibers 12-1 to 12-8, and the heat shrink tube 26a shrinks and tightens the optical fibers 12-1 to 12-8 and the support 28 together. This state is shown in FIG. 3(5). Since the optical fibers 12-1 to 12-8 are faced on the flat surface of the support 28, the optical fibers 12-1 to 12-8 are maintained in ribbonized flat state. The adhesive 40 is applied to the optical fibers 12-1 to 12-8 in advance in such a manner to protrude from the heat shrink tube 26a. With this operation, as explained above, the bending of the optical fibers 12-1 to 12-8 around the support 28, namely around the optical fiber holder 26, can be suppressed.

As explained above, the optical fiber holder 26 to firmly hold the optical fibers 12-1 to 12-8 is set on the stand 32 and the adhesive 30 is poured over around the optical fiber holder 26 to adhere the holder 26 to the stand 32. Before or after the optical fiber holder 26 is fixed on the stand 32, the stand 32 is fixed on the baseplate 24 with the screw bolts 34.

The section of the optical fiber holder 26 becomes approximately semicylindrical after the shrink of the heat shrink tube 26a as shown in FIG. 1, and the ribbonized optical fibers 12-1 to 12-8 are adhered on the flat surface of the support 28. This condition makes it easier to set the optical fiber holder 26 after the heat-shrinking on the stand 32.

In the optical fiber holder 26, the optical fibers 12-1 to 12-8 are one-sided. In this explanatory embodiment, by utilizing this status, when two optical fiber holders are set in parallel, respective optical fibers can be located adjacent to each other. This means that when optical fibers pulled out from a single optical cable are held by two optical fiber holders, the distance between the optical cable and the optical fiber holders can be shortened.

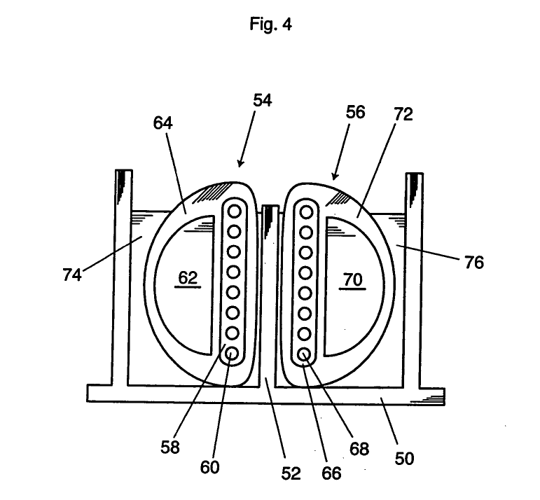

FIG. 4 shows a vertical side view of the two optical fiber holders fixed on a stand in parallel. A stand 50 corresponding to the stand 32 has a partition wall 52 in the middle and is capable of housing two optical fiber holders 54 and 56 with the partition wall 52 between them. Each of the optical fiber holders 54 and 56 has a configuration identical to that of the optical fiber holder 26. That is, the optical fiber holder 54 holds optical fibers 60 ribbonized by an adhesive 58 and a support 62 in a heat shrink tube 64, and the optical fiber holder 56 holds optical fiber 68 ribbonized by an adhesive 66 and a support 70 in a heat shrink tube 72. Each of the supports 62 and 70 comprises a material identical to that of the support 28. The adhesives 58 and 66 are applied in such a manner to protrude from the optical fiber holders 54 and 56 on both ends respectively. However, similarly to the adhesive 40, the adhesives 58 and 66 are not necessarily applied evenly all over the optical fibers 60 and 68 in the optical fiber holders 54 and 56 respectively.

As shown in FIG. 4, the optical fiber holders 54 and 56 are set on the stand 50 in such a manner that a flat side, namely the side adjacent to the optical fibers 60 and 68, of each of the optical fiber holders 54 and 56 faces to the partition wall 52 of the stand 50, and the optical fiber holders 54 and 56 are fixed on the stand 50 by adhesives 74 and 76 respectively. Before or after the optical fiber holders 54 and 56 are fixed on the stand 50, the stand 50 is fixed on a baseplate identical to the baseplate 24 with screw bolts.

In the configuration shown in FIG. 4, the fibers 60 and 68 are practically apart from each other by the distance equal to the sum of the thickness of the heat shrink tubes 64 and 72 of the optical fiber holders 54 and 56 and thickness of the partition wall 52. In a conventional configuration to sandwich ribbonized optical fibers with two supports, the distance between two sets of ribbonized optical fibers becomes longer than the thickness of the two supports. However, in the explanatory embodiment, since no support is inserted between two sets of ribbonized optical fibers, the distance between the two sets of ribbonized optical fibers becomes greatly narrower compared to that of the conventional configuration. Accordingly, the length to pull out optical fibers from an optical cable can be shortened. That is, the fiber length used for retaining the optical fibers can be shortened. This contributes to miniaturize joint parts of an optical cable and optical fiber retainer.

It is not difficult to set the optical fiber holders 54 and 56 facing each other on the stand 50 without the partition wall 52. That is, the partition wall 52 can be omitted. In this case, the distance between the optical fibers 60 and 68 can be even more shortened.

Although the explanatory embodiment to retain optical fibers in an optical cable having high strength steel wires is explained, this invention is applicable to general cases when a plurality of optical fibers are retained in a lump.

As readily understandable from the aforementioned explanation, according to the invention, it is possible to suppress the loss increase caused by retaining optical fibers and to make a retainer part miniaturized.

While the invention has been described with reference to the specific embodiment, it will be apparent to those skilled in the art that various changes and modifications can be made to the specific embodiment without departing from the spirit and scope of the invention as defined in the claims.

1. An optical fiber retaining method comprising steps of:
forming ribbonized optical fibers by applying a first adhesive to a plurality of optical fibers which align like a ribbon;
inserting the ribbonized optical fibers and a support into a heat shrink tube;
holding the ribbonized optical fibers and support firmly in the heat shrink tube by heating the heat shrink tube to shrink; and
fixing the shrunken heat shrink tube on a stand by a second adhesive; wherein the first adhesive is applied to the plurality of optical fibers at inside and outside of the heat shrink tube.

2. The method of claim 1 wherein the plurality of optical fibers are the ones pulled out from an optical cable.

3. The method of claim 1 wherein the strength of the first adhesive is in the middle of the strength of the support and that of the optical fibers.

4. The method of claim 2 wherein the support comprises a column having a semicylindrical section.

5. The method of claim 4 wherein the ribbonized optical fibers are disposed adjacent to a flat side of the support in the heat shrink tube.

6. The method of claim 1 wherein the support comprises glass.

7. The method of claim 1 wherein the support is inserted in the heat shrink tube in advance and then the ribbonized optical fibers are inserted in an empty space in the heat shrink tube.

8. The method of claim 1 wherein the support and heat dissolving tube are inserted in the heat shrink tube in advance and then the ribbonized optical fibers are inserted in the heat dissolving tube.

9. An optical fiber retainer comprising:
an adhesive to adhere a plurality of optical fibers together which align like a ribbon to form ribbonized optical fibers;
a heat shrink tube to contain the ribbonized optical fibers and a support to firmly hold the ribbonized optical fibers and the support through heat-shrinking; and
a stand to hold the heat shrink tube; wherein the adhesive is applied to the plurality of optical fibers at inside and outside of the heat shrink tube after the heat-shrinking.

10 The apparatus of claim 9 wherein the strength of the adhesive is in the middle of the strength of the support and that of the optical fibers.

11. The apparatus of claim 9 wherein the support comprises a column having a semicylindrical section.

12. The apparatus of claim 9 wherein the ribbonized optical fibers are disposed adjacent to a flat side of the support in the h at shrink tube.

13. The apparatus of claim 9 wherein the support comprises glass.

14. The apparatus of claim 9 further comprising a heat dissolving tube inserted in the heat shrink tube, the ribbonized optical fibers being inserted to the heat dissolving tube.

15. An optical fiber retainer comprising:
a first optical fiber holder to contain a first ribbonized optical fibers and a first support with a semicylindrical section and to hold the first ribbonized optical fibers disposed adjacent to a side of the first support;
a second optical fiber holder to contain a second ribbonized optical fiber and a second support with semicylindrical section and to hold the second ribbonized optical fibers disposed adjacent to a side of the second support; and
a stand to hold the first and second optical fiber holders so that the first ribbonized optical fibers held by the first optical fiber holder and the second ribbonized optical fibers held by the second optical fiber holder are close to each other.

16. The retainer of claim 15 wherein each of the first and second supports comprises a column having a semicylindrical section.

17. The apparatus of claim 15 wherein the first optical fiber holder holds the first ribbonized optical fibers adjacent to a flat side of the first support and the second optical fiber holder holds the second ribbonized optical fiber adjacent to a flat side of the second support.

18. The apparatus of claim 15 wherein each of the first and second supports comprises glass.

19. The apparatus of claim 15 wherein the first optical fiber holder comprises:
an adhesive to adhere a plurality of optical fibers that align like a ribbon each other to form the first ribbonized optical fibers; and
a heat shrink tube to contain the first ribbonized optical fibers and the first support to hold the first ribbonized optical fibers and first support firmly by heat-shrinking; wherein
the adhesive is applied to the plurality of optical fibers at inside and outside of the heat shrink tube after the heat-shrinking.

20. The apparatus of claim 19 wherein the strength of the adhesive is in the middle of the strength of the first support and that of each optical fiber forming the first ribbonized optical fibers.

21. The apparatus of claim 19 wherein the first support comprises a column having a semicylindrical section.

22. The apparatus of claim 19 wherein the first ribbonized optical fibers are disposed adjacent to a flat side of the first support in the heat shrink tube.

23. The apparatus of claim 19 wherein the first optical fiber holder further comprises a heat dissolving tube inserted in the heat shrink tube, the first ribbonized fibers being inserted in the heat dissolving tube.
